(19) United States
(12) Patent Application Publication
(10) Pub. No.: US 2004/0118355 A1
(43) Pub. Date: Jun. 24, 2004

(54) Water suck device for feeding favorite domestic animals

(76) Inventor: Yao-Hsun Huang, Feng Yuan City (TW)

Correspondence Address: YAO-HSUN HUANG, P.O. Box 697, Feng-Yuan City, Taichung Hsien, 420, TW

(21) Appl. No.: 10/600,327

(22) Filed: Jun. 23, 2003

(30) Foreign Application Priority Data
Dec. 23, 2002 (TW) 091221222

(51) Int. Cl. A01K 7/00

(52) U.S. Cl. 119/72.5

(57) ABSTRACT

A suck device for feeding favorite domestic animals includes a bottle containing the water, a lid engaged a neck of the bottle, an oblique pipette extended outward from a bottom of the lid communicating with the bottle and having an outlet in free end, a ball movably disposed into the oblique pipette and normal stopping the outlet. It is characterized in that a water guiding pipe of predetermined length movably disposed into the oblique pipette having a lower end stopped against the ball and an upper end reaching to the water interface in the lid by which the water from the bottle can be smoothly and continuously flow out when the animal lick and sucks the outlet of the oblique pipette.

### BACKGROUND OF THE INVENTION

The present invention relates to water drinking device and more particularly to a water suck device for feeding favorite domestic animals.

To raise a favorite domestic animals, people have to prepare a container and a water feeding device to feed the animals. A suckling type of water feeding device is more welcome by the owners who feed the animals because does not wet the circumstance and the water does not splash the floor.

FIG. 1 shows a prior suck device which comprises a bottle 1 containing the water, a neck having outer threads 2 engaged with the inner threads 3 of a lid, a oblique pipe 4 extended outward from the bottom of the lid, a ball disposed the reduced opening of the free end of the pipe 4 and a balance weight 6 above the ball 5.

When the domestic animal licks the free end of the pipe 4, the ball will move upward to permit the water flowing out of the pipe 4 to feed the animal. This arrangement could keep the environmental sanitation. However, after the animal sucks several times, the water may be stopped due to the pipe 4 is narrow that the external air could not smoothly and convectionally enter into the pipe 4. If a hole is punched on the bottle 1 that is helpfully to permit the water flowing out from the pipe 4. But the wall will leakout when replenish the water into the bottle 1.

### SUMMARY OF THE PRESENT INVENTION

The present invention has a main object to provide a water suck device for feeding favorite domestic animals which the water smoothly flows out when the animal sucks the pipette and drinks enough water without punching a hole in the bottle.

Accordingly, the water suck device of the present invention comprises generally a bottle for containing the fresh water, a lid connected to a neck of the bottle, an oblique pipette centrally connected to the bottom of the lid and a ball movably disposed into to pipette and normally blocked the outlet of the pipette. It is characterized in that a water guiding pipe disposes in the pipette above the ball and moves upward along with the ball so as to guide the water smoothly flowing out of the pipette.

The present invention will become more fully understood by reference to the following detailed description thereof when read in conjunction with the attached drawings.

### BRIEF DESCRIPTION OF THE DRAWINGS

FIG. 1 is a sectional view to show a water suck device according to a prior art,

FIG. 2 is an exploded perspective view to show a water suck device of the preferred embodiment according to the present invention,

FIG. 3 is a sectional view to show the assembly of FIG. 2,

FIG. 4 is a sectional view to show that the ball together with the water guiding pipe move upward to permit the water flowing out of the outlet, and

FIG. 5 is a perspective view to show an outlook of the water suck device of the present invention.

### DETAILED DESCRIPTION OF THE PREFERRED EMBODIMENT

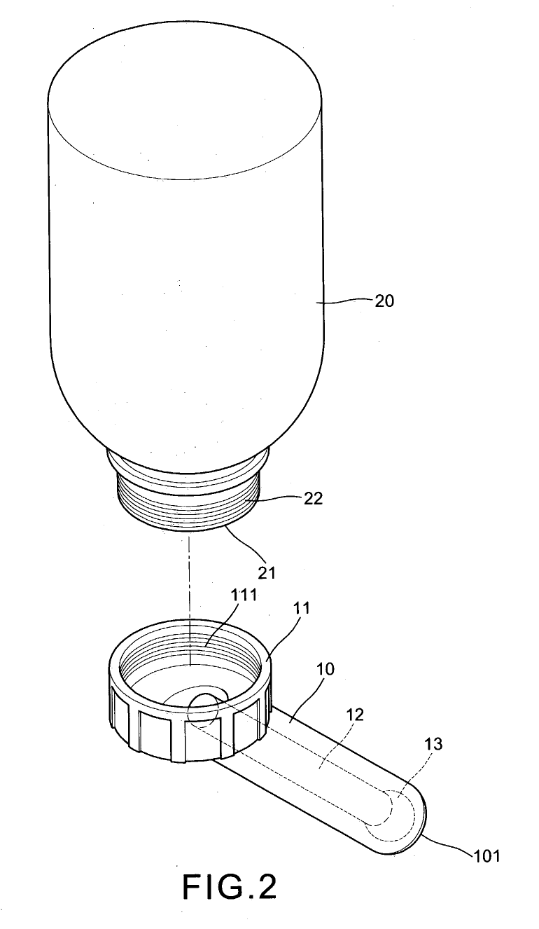

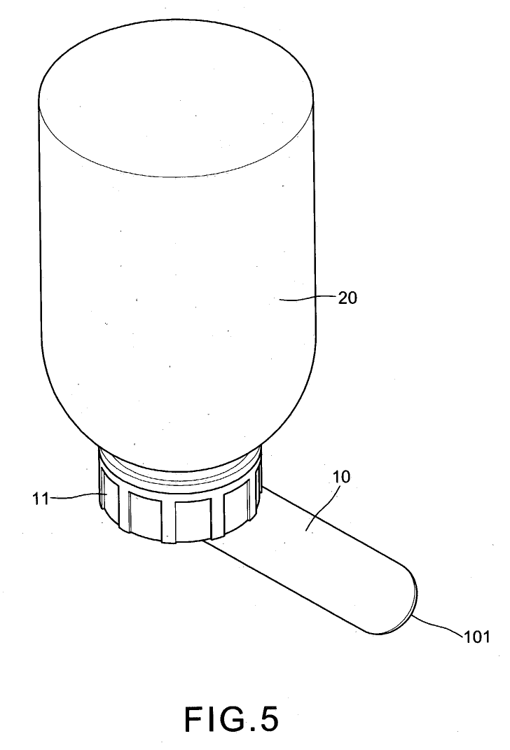

With reference to FIGS. 2, 3 and 5 of the drawings, the water suck device of the present invention comprises an oblique pipette 10 centrally connected to the bottom of a lid 11 communicating with the bottle 20, the lid 11 having threads 111 on inner periphery, a water guiding pipe 12 disposed into the oblique pipette 10, a ball 13 disposed into the pipette 10 engaged with the lower end of the water guiding pipe 12 and normally blocked a reduced outlet 101 of the oblique pipette 10, a bottle 20 for containing fresh water having a neck 21 and threads 22 on the outer periphery of the neck 21 engaged with the inner threads 111 of the lid 11. The water guiding pipe 12 has predetermined length. Its lower end attaches the ball 13 and its upper end positions beneath the lid 11.

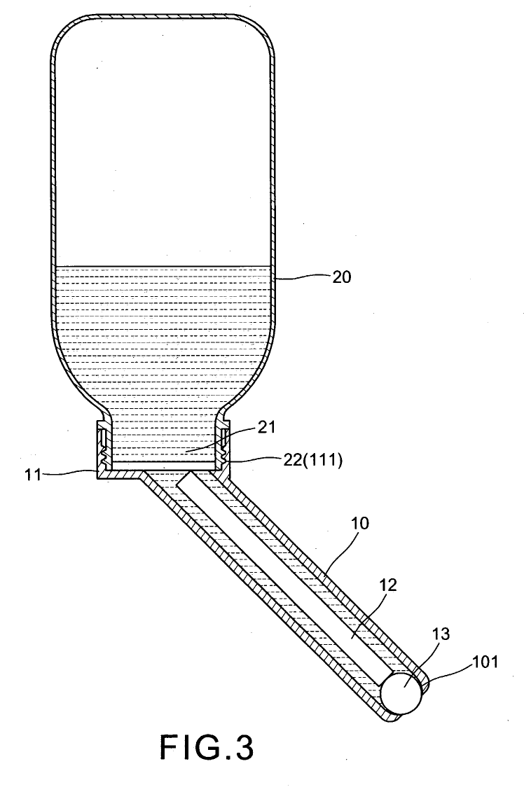

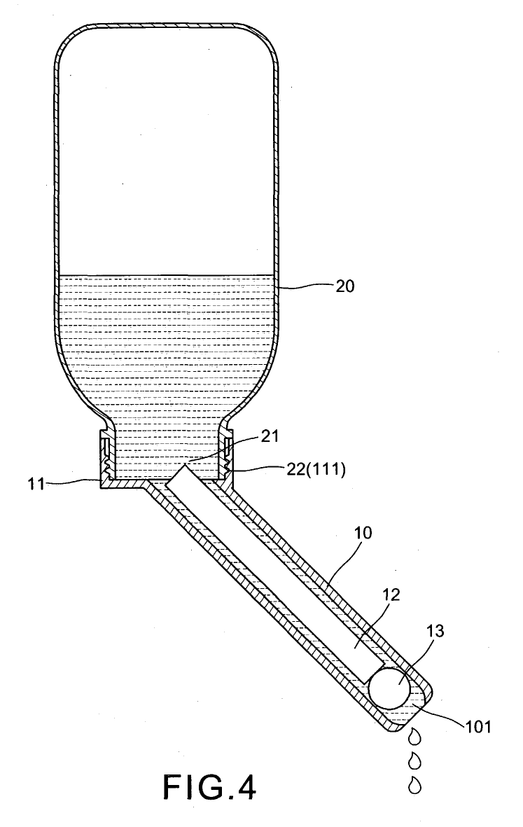

When puts the bottle 20 upside down, the ball 13 automatically moves down on its own weight and blocks the outlet 101 (as shown in FIG. 3) which may be replaced with a sealing ring. When the animal licks the outlet 101, the ball 13 together with the water guiding pipe 12 are actuated by the tongue of the animal to move upward while the upper end of the water guiding pipe 12 breaks through the water interface in the lid 11 and smoothly guides the water flowing out of the outlet 101 (as shown in FIG. 4). Since the water interface is disturbed, the external air promptly enters into the bottle 20 to balance the pressure in the bottle 20 so that water will continuously flow out without stopping. When the animal had enough water and stopped to suck the oblique pipette 10, the ball 13 and the water guiding pipe 12 will automatically block the outlet 101 again on their own weight.

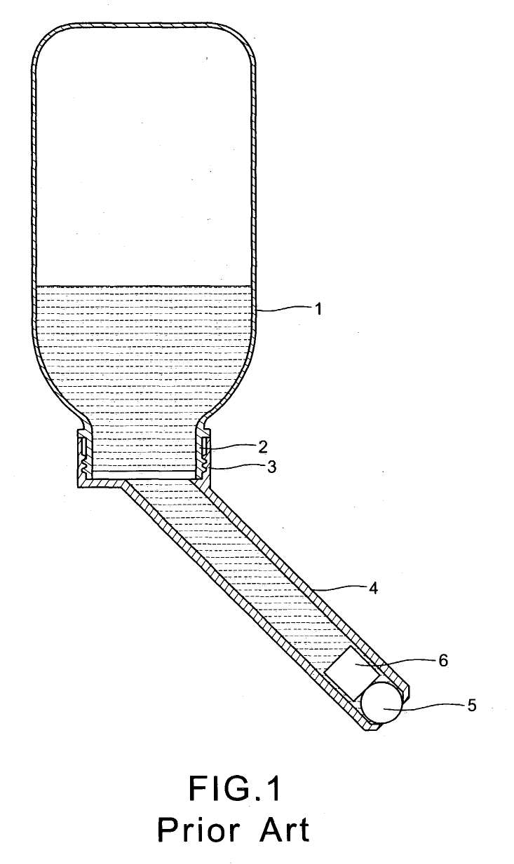

It is known that the length of the water guiding pipe 12 is very important. If the length of the water guiding pipe 12 is reduced and its upper end positioned at a middle portion of the oblique pipette 10, the animal can only drink the water inside the pipe 12. No more water can be flow out from the bottle 20. So that the water guiding pipe 12 must reach to the water interface in the lid 11. Furthermore, the suck device of the present invention facilitates the external air enter into the bottle 20 without requiring to punch a hole in the bottle 20. Besides, the balance weight 6 of the prior art (as shown in FIG. 1) is just used to press the ball 5 and can not break through the water interface in the bottle 1. So that the structure and function of the present invention are completely difference from the prior art.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A suck device for feeding favorite domestic animals compring:
a bottle for containing fresh water and having a neck and threads on outer periphery of the neck;
a lid having threads on inner periphery engaged with the threads of the neck;
an oblique pipette centrally extended from a bottom of the lid having a reduced outlet in free end, a ball movably disposed into the oblique pipette and normally blocking the outlet and a water guiding pipe of predetermined length disposed into the oblique pipette communicating with the bottle and having a lower end stopped against the ball and an upper end reach to the bottom of the lid;
whereby, the water guiding pipe can smoothly and continuously guide the water flowing out of the outlet when an animal licks the outlet to actuate the ball and the water guiding pipe moving upward.

2. The suck device as recited in claim 1 wherein said outlet may be replaced with a sealing ring.
